(19) United States
(12) Patent Application Publication
(10) Pub. No.: US 2020/0081239 A1
(43) Pub. Date: Mar. 12, 2020

(54) BODY MOUNTED VIEWING INSTRUMENT SUPPORT APPARATUS AND METHOD

(71) Applicant: Jaremy D. Hamm, Billings, MT (US)

(72) Inventor: Jaremy D. Hamm, Billings, MT (US)

(21) Appl. No.: 16/128,516

(22) Filed: Sep. 12, 2018

(51) Int. Cl. G02B 23/18; G02B 7/00

(52) U.S. Cl. CPC G02B 23/18; G02B 7/002

(57) ABSTRACT

The invention is a body mounted support apparatus and method for supporting and stabilizing a viewing instrument, and allowing for viewing adjustment. The invention has a pack, a telescoping monopod and the viewing instrument. A port member socket is fitted within the pack, for supporting and stabilizing the telescoping monopod. The telescoping monopod has a monopod shaft connecting to a generally rectangular platform by a quick releasing means engaging a releasing catch means. The monopod shaft has at least two pod sections, each having at least one detachable vertical adjusting means allowing vertical adjustment of the telescoping monopod to a user's eyesight level and detachment of the at least two pod sections. The pack has at least one sturdy monopod compartment accommodating the at least two pod sections. An adjustable and lockable hinge allows the user to adjust a viewing angle level.

### FIELD OF THE INVENTION

This patent disclosure relates to a body mounted support apparatus and method for supporting and stabilizing a viewing or optical instrument while user is in the field, and more particularly for independently supporting a viewing instrument such as a camera and allowing for viewing adjustment of the instrument.

### BACKGROUND OF THE INVENTION

While in the outdoors in the field, one important consideration of a photographer, bird watcher, hunter or other observer of wildlife and natural phenomenon is being able to have a stable, reliable and convenient supporting apparatus for maintaining a camera or ocular instrument in one position, as well as being able to adjust that viewing instrument to a different level of viewing when desired. This activity and need applies to viewing at sporting event and other activities and events.

Some known devices provide a degree of stability for the user of viewing instruments, allowing the instrument to be supported in some manner by the torso of the user, thus allowing the user's hands to be free to adjust the viewing instrument when desired. However, there is a need with the activity to take the strain off the neck, arms and shoulders of the user to allow the user to better enjoy his or her pastime passion and the outdoor experience. An apparatus not currently known is required to provide a solution to relieve arm and should strain as well as provide a stabilized viewing experience for the users of viewing instruments such as a camera or binoculars. Significant amounts of discomfort and strain come from extended use of a pair of binoculars, for example. Extended use not only causes discomfort but may compromise the viewing image stability. An apparatus and method to solve these two issues and free the user from long term use discomfort.

The references described in the related art do not disclose features of the present invention and would not be as suitable for the required purpose of the present invention hereinafter described. Optical device support assemblies are found in the related art, exemplified by U.S. Pat. No. 5,819,461 to Killian (“Killian”); U.S. Pat. No. 3,661,308 to Walters (“Walters”); U.S. Pat. No. 9,841,659 (“Tipson”); U.S. Pat. No. 5,598,963 to Buswell (“Buswell”); and U.S. Pat. No. 5,738,256 to Goff et al. (“Goff”). Killian discloses a support apparatus for cameras and binoculars, comprising a waist belt to which a vertically disposes support is removably secured, the support of Killian, including an elbow rest for use during viewing. Walters discloses a telescoping monopod secured to a waist belt and including a neck strap, the receiving end of the monopod is laterally adjustable from the user's body. Goff discloses a body worn support for a monopod, as well as a platform, strap and quick release, with a waist belt hingedly secured to the monopod, for use with a binoculars and other purposes. Tipson discloses a camera support having a platform, with a monopod resting on a body worn support with a shoulder strap for supporting a fixed platform that rests against the waist of the user. The monopod in Tipson is secured to the fixed platform and the opposite end includes a support for mounting a camera. Buswell discloses a body support of a camera comprising a pair of waist straps connected to a pack and support a first end of the telescopic monopod, and an opposite end hingedly secured to a camera.

Although the references variously teach a pack or a strap system, assembly or apparatus fitted to the upper torso of the user's body and a telescopic monopod that is secured to the pack or strap system, none of the references teach a monopod that is angularly adjustable between its first and second ends, enabling a viewing instrument, such as binoculars, to be angularly adjusted to the same angle as the user's head during viewing.

None of the references in the prior art contain every feature of the present invention, and none of these references in combination disclose, suggest or teach every feature of the present invention. The present invention is neither disclosed nor suggested by the prior art.

The foregoing and other objectives, advantages, aspects, and features of the present invention will be more fully understood and appreciated by those skilled in the art upon consideration of the detailed description of a preferred embodiment, presented below in conjunction with the accompanying drawings.

### SUMMARY OF THE INVENTION

The present invention is a body mounted support apparatus and method for supporting and stabilizing a viewing or optical instrument, for independently supporting a viewing instrument, such as a camera and allowing for viewing adjustment of the instrument. The invention comprises a pack having at least one pack compartment, a pack strap securing the pack to an upper front torso of a user, a telescoping monopod and a viewing instrument. A port member socket is fitted within the pack, which is upwardly oriented for freely receiving and securely supporting and stabilizing the telescoping monopod.

The telescoping monopod comprises a monopod shaft, a platform end, a generally rectangular platform, and an opposing port end, the platform end supporting and cooperatively connecting to a generally rectangular platform. The monopod shaft has at least two pod sections, each having at least one detachable vertical adjusting means allowing vertical or telescoping adjustment of the telescoping monopod to a user's eyesight level and detachment of the at least two pod sections. The generally rectangular platform comprises an upper platform surface, an opposing lower platform surface and a removable platform strap, which freely secures the viewing instrument onto the upper platform surface. The pack has at least one sturdy monopod compartment accommodating the at least two pod sections, and a compartment cap securing the at least two pod sections within the at least one sturdy monopod compartment.

A quick releasing means is located on the monopod shaft adjacent to the platform end and mounted to an adjustable and lockable hinge. A releasing catch means is located centrally on the opposing lower platform surface, and the adjustable and lockable hinge is located along the monopod shaft. The quick releasing means cooperatively and securely engages the releasing catch means, securing the monopod shaft to the generally rectangular platform. The viewing instrument comprises one of a camera or any type of ocular instrument used in the field for telescopic viewing and/or visual recording of wildlife, and may be a monocular, a hunting scope or a pair of binoculars, or other ocular instrument employed. The adjustable and lockable hinge allows the user to adjust a viewing angle level with the user's eyesight level. The user may thereby adjust the generally rectangular platform, in turn adjusting the viewing angle through the viewing instrument.

All of the elements of the present invention of a body mounted viewing instrument support apparatus and method are designed to work together. A telescoping monopod would not be nearly as effective if not stabilized by the pack. The invention provides for a dedicated “mounting pocket” in the pack, the port member socket, in which to place the shaft socket end of the monopod shaft for stability. The pack provides stability that cannot achieved by the user merely holding onto a viewing instrument, or telescoping monopod itself, with the pack. The viewing is stabilized by support of the viewing instrument on a much more stable platform, the generally rectangular platform, than by the user simply holding the viewing instrument with his or her hands.

The pack is also critical to ease shoulder strain for the user and for allowing for the user's extended time viewing through the viewing instrument. In addition, the present invention also relieves the tension on the shoulders of the user, by allowing the user to hold the telescoping monopod and generally rectangular platform at chest, or upper front torso level in the pack which is not only more comfortable but also adds to the stability.

By attaching the viewing instrument to the generally rectangular platform and stabilizing the telescoping monopod in the pack, the user is able to support the viewing instrument for angled viewing without having to hold it to the user's eyesight level with his or her hands above the shoulders. The invention also provides for an easy way to carry all the elements of the invention and still be highly mobile while hiking and have them readily available for use. The pack has at least one sturdy monopod compartment to carry the at least two pod sections of the telescoping monopod. There is at least one pack compartment, located in the front of the pack, available to transport other elements, such as the generally rectangular platform. The pack provides for an efficient, safe, secure and comfortable way to carry the entire system with dedicated pockets and sleeves for each of the components.

The aforementioned features, objectives, aspects and advantages of the present invention, and further objectives and advantages of the invention, will become apparent from a consideration of the drawings and ensuing description.

### BRIEF DESCRIPTION OF THE SEVERAL VIEWS OF THE DRAWINGS

The foregoing features and other aspects of the present invention are explained and other features and objects of the present invention will become apparent in the following detailed descriptions, taken in conjunction with the accompanying drawings. However, the drawings are provided for purposes of illustration only, and are not intended as a definition of the limits of the invention.

FIG. 1 illustrates an elevated front view of one embodiment of the present invention, depicting that portion of the present invention comprising a telescoping monopod and a generally rectangular platform.

FIG. 2 illustrates a perspective view of the one embodiment of the present invention, a body mounted viewing instrument support apparatus, having a pack, a viewing instrument and the telescoping monopod with the generally rectangular platform.

FIG. 3 illustrates a partial perspective view of one embodiment of the present invention, depicting the upper portion of the telescoping monopod, an adjustable lockable hinge and a connected opposing lower platform surface of the generally rectangular platform.

FIGS. 4A and B illustrate two top planar views of the top of an upper platform side of the generally rectangular platform, having a removable platform strap.

FIG. 4A illustrates the removable platform strap attached to a latching means at its opposing latching end.

FIG. 4B illustrates the removable platform strap as unattached to the latching means, having pivoted away from the generally rectangular platform at a strap connecting and pivoting means.

FIG. 5 illustrates a partial perspective view of an embodiment of the present invention, depicting the pack to be worn by a user.

FIGS. 6A and B illustrate two perspective views of the generally rectangular platform to one embodiment of the present invention.

FIG. 6A illustrates the opposing lower platform surface of the generally rectangular platform, including a releasing catch means for attaching the telescoping monopod.

FIG. 6B illustrates an elevated front view of the generally rectangular platform, including the adjustable lockable hinge attached to the opposing lower platform surface.

FIG. 7 illustrates an elevated and perspective view of a portion of a pack back side, depicting an opposing port end to the telescoping monopod inserted into a port member socket.

FIGS. 8A-C, illustrate three perspective views of embodiments of the present invention, the body mounted viewing instrument support apparatus.

FIG. 8A illustrates the invention having a monocular for a viewing instrument.

FIG. 8B illustrates the invention having a hunting scope for a viewing instrument.

FIG. 8C illustrates the invention having a camera for a viewing instrument.

### DETAILED DESCRIPTION OF THE INVENTION

The present invention will now be described more fully hereinafter with references to the accompanying drawings, in which the preferred embodiment of the invention is shown. This invention, however, may be embodied in different forms, and should not be construed as limited to the embodiments set forth herein. Rather, the illustrative embodiments are provided so that this disclosure will be thorough and complete, and will fully convey the scope of the invention to those skilled in the art. It should be noted, and will be appreciated, that numerous variations may be made within the scope of this invention without departing from the principle of this invention and without sacrificing its chief advantages. Like numbers refer to like elements throughout.

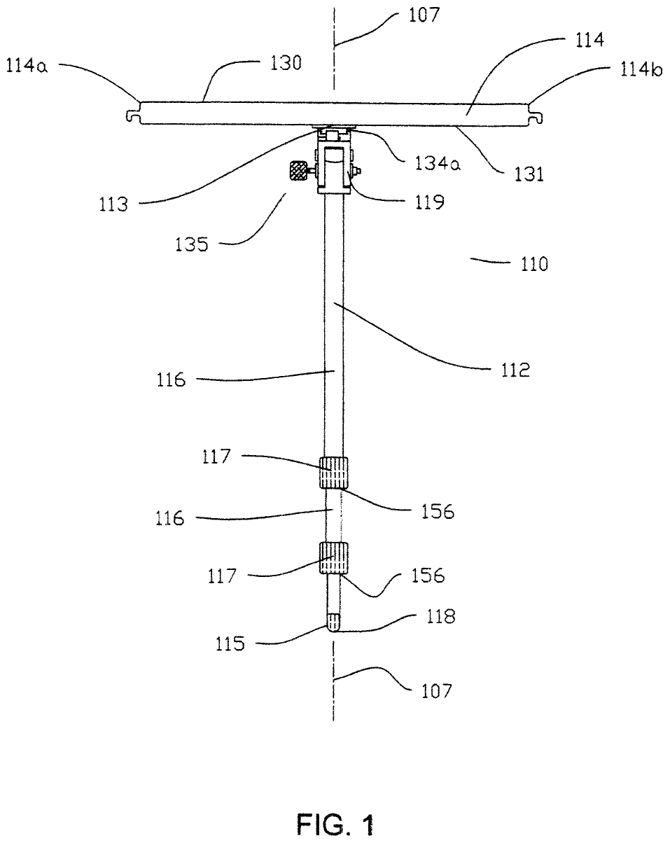

Turning now to FIGS. 1, 2 and 5 of the present invention, a body mounted viewing instrument support apparatus 100 comprises a pack 101 having at least one pack compartment 102, a pack front side 170, an opposing pack back side 180, a pack strap 103 securing the pack 101 to an upper front torso 104 of a user 105, and at least one shoulder strap 106 to install the pack 101 to the upper front torso 104 of the user 105.

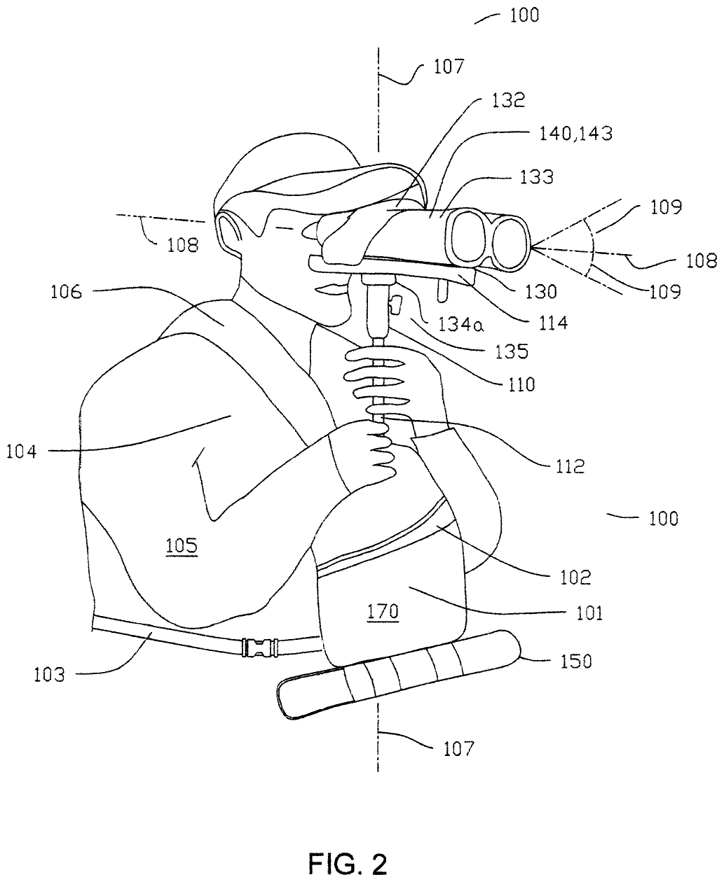

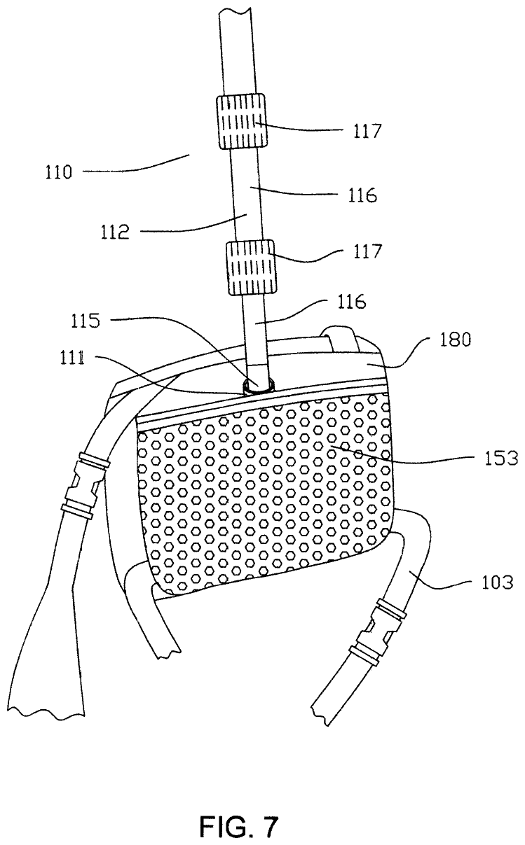

A port member socket 111 is fitted within the pack 101, as shown in FIG. 7 in this embodiment of the present invention, and centrally and firmly disposed proximal to the pack strap 103 adjacent to the upper front torso 104. The port member socket 111 is upwardly oriented for freely receiving a telescoping monopod 110, shown in FIGS. 1 and 2. The pack 101, having the port member socket 111 fitted within the pack 101, at the opposing pack back side 180, securely supports and stabilizes the telescoping monopod 110, allowing and providing use of the body mounted viewing instrument support apparatus 100 by the user 105, which use may be hands free.

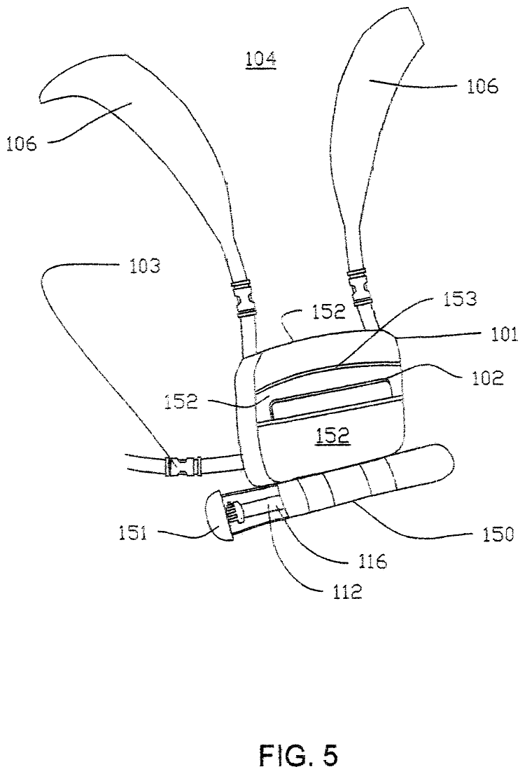

The telescoping monopod 110, shown in FIGS. 1, 2 and 7, comprises a monopod shaft 112, a platform end 113, a generally rectangular platform 114, and an opposing port end 115, the platform end 113 supporting and cooperatively connecting to the generally rectangular platform 114. The monopod shaft 112, as shown in FIG. 1 in particular, is a tubular shaft having at least two pod sections 116, each having at least one detachable vertical adjusting means 117 allowing vertical or telescoping adjustment of the telescoping monopod 110 and detachment of the at least two pod sections 116, making the telescoping monopod 110 convenient for storage and transport, as depicted in FIG. 5. The generally rectangular platform 114 has a generally rectangular shape which may have sharp or rounded corners.

As shown in FIGS. 1 and 7, the opposing port end 115 to the present invention has a shaft socket fitting 118 removably and securely anchoring within the port member socket 111 at the opposing port end 115. As shown in FIGS. 1 and 2, the at least one detachable vertically adjusting means 117 is a means to allow the telescoping monopod 110 to be vertically adjustable to a user's eyesight level 108. The detachable vertically adjusting means 117 of Claim 7 further comprises cooperative threaded connections 156, providing for the vertical adjustment, as well as detachment, of the telescoping monopod 110. The cooperative threaded connections 156 to the at least one detachable vertically adjusting means 117 should be understood to be threaded connections commonly used in tubularly connected segments, such as the found with the at least two pod sections 116 in the monopod shaft 112, shown in FIG. 1. The at least two pod sections 116 may be made of carbon fiber.

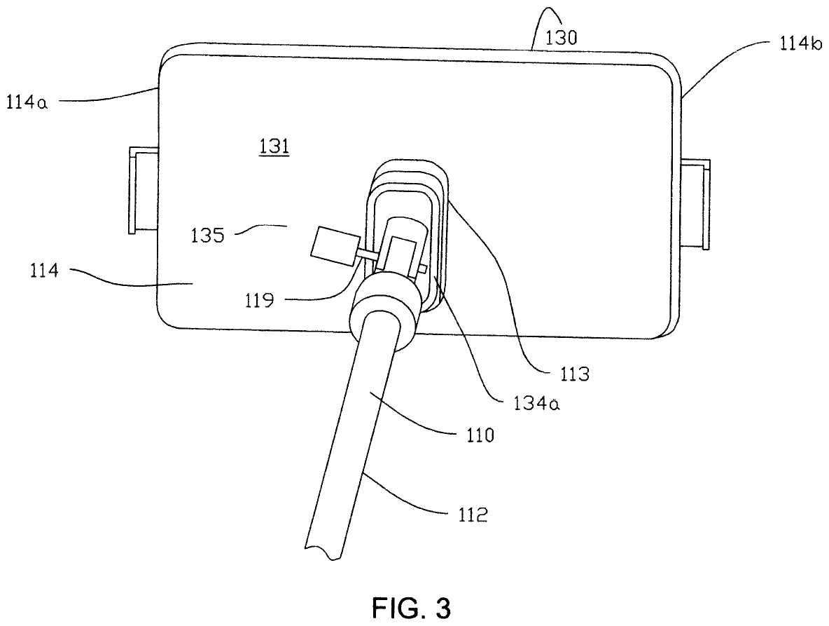

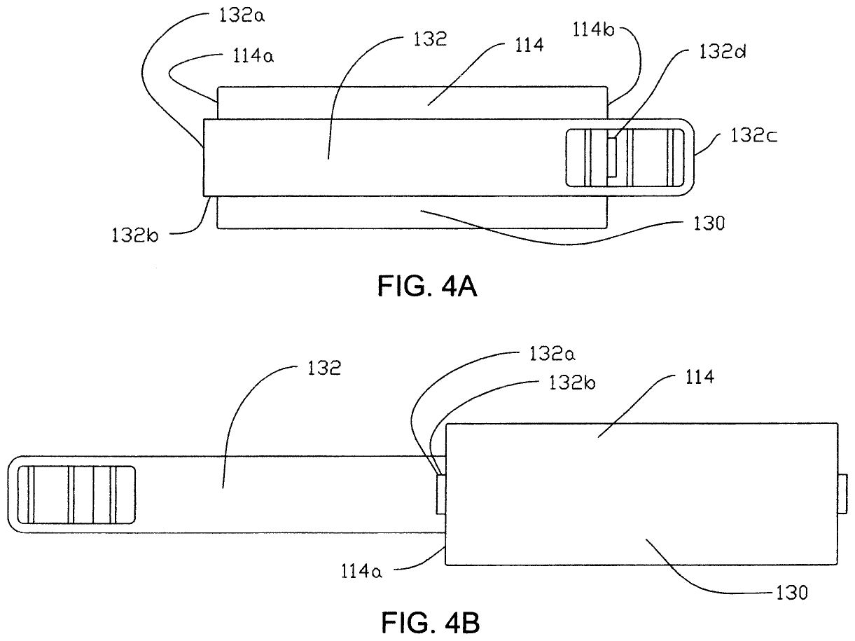

In the present invention as shown in FIGS. 1, 3, 6A and 6B, the generally rectangular platform 114 comprises an upper platform surface 130 and an opposing lower platform surface 131, and a removable platform strap 132 (depicted in FIGS. 2, 4A and 4B), which freely secures a viewing instrument 133 onto the upper platform surface 130. The generally rectangular platform 114 is laterally or horizontally disposed on the monopod shaft 112 to the telescoping monopod 110, where the generally rectangular platform 114 is cooperatively and centrally received at the opposing lower platform surface 131 at the platform end 113 of the monopod shaft 112. The telescoping monopod 110 is longitudinally or vertically disposed and oriented along a longitudinal axis at the upper front torso 104 of the user 105.

In the present invention, the elements of the telescoping monopod 110, shown in FIG. 1, may be constructed in part or whole of carbon fiber, resilient plastic, and/or aluminum or titanium, as these materials commonly used in the industry to make such equipment.

The pack 101, shown in FIGS. 2, 5 and 7; and its other components including the pack strap 103 and at least one shoulder strap 106, may be constructed or made of a plurality of fabric material pieces sown together 152, having fabric of any number of types of natural and synthetic materials commonly used in the industry for producing such equipment, including cordera, a synthetic nylon fabric material. The pack 101 has at least one sturdy monopod compartment 150, made of the same material as the pack 101, and accommodating the at least two pod sections 116, and a compartment cap 151 which as part of the at least one sturdy monopod compartment 150 securing the at least two pod sections 116 within the at least one sturdy monopod compartment 150. The at least one sturdy monopod compartment 150 is constructed of a plurality of fabric material pieces sown together 152 and constructed of padded fabric material 153, providing protection for the at least two pod sections 116 and other equipment stored and transported in the pack 101. The pack 101 securely supports and stabilizes the telescoping monopod 110, allowing for efficient and convenient use of the body mounted viewing instrument support apparatus 100 by the user 105 to view birds, natural scenes, other wildlife and other scenes and objects.

The body mounted viewing instrument support apparatus 100, shown in FIGS. 2, 3, 6A and 6B, further comprises a quick releasing means 134a located on the monopod shaft 112 located adjacent to the platform end 113 and a releasing catch means 134b located centrally on the opposing lower platform surface 131 of the generally rectangular platform 114. An adjustable and lockable hinge 135 is located along the monopod shaft 112 between the quick releasing means 134a and the opposing port end 115, proximal to, and attaching to, the quick releasing means 134a. The quick releasing means 134a cooperatively and securely engages the releasing catch means 134b, securing the monopod shaft to the generally rectangular platform 114. The quick releasing means 134a conveniently and quickly releases the monopod shaft 112 from the generally rectangular platform 114 at the releasing catch means 134b.

Shown in FIGS. 1, 3, 6A and 6B; the releasing catch means 134b may comprise a slide slot receiving slot, a cotter pin receiving slot, a snap lever receiving port or a pressure catch port 138b, or other releasing catch means commonly used for receiving the quick releasing means 134a. The quick releasing means 134a may in turn comprise a cotter pin, a spring loaded snap lever, or a pressure engaging mechanism, or other type of quick releasing means for engaging the appropriately matching releasing catch means 134b. As shown in FIGS. 2, 3, 6A and 6B, the quick releasing means 134 is mounted to the adjustable and lockable hinge 135. The quick releasing means 134a and the releasing catch means 134b are means, acting together, to quickly engage and release the generally rectangular platform 114 to the telescoping monopod 110. The adjustable and lockable hinge 135 and the quick releasing means 134a may be made of aluminum.

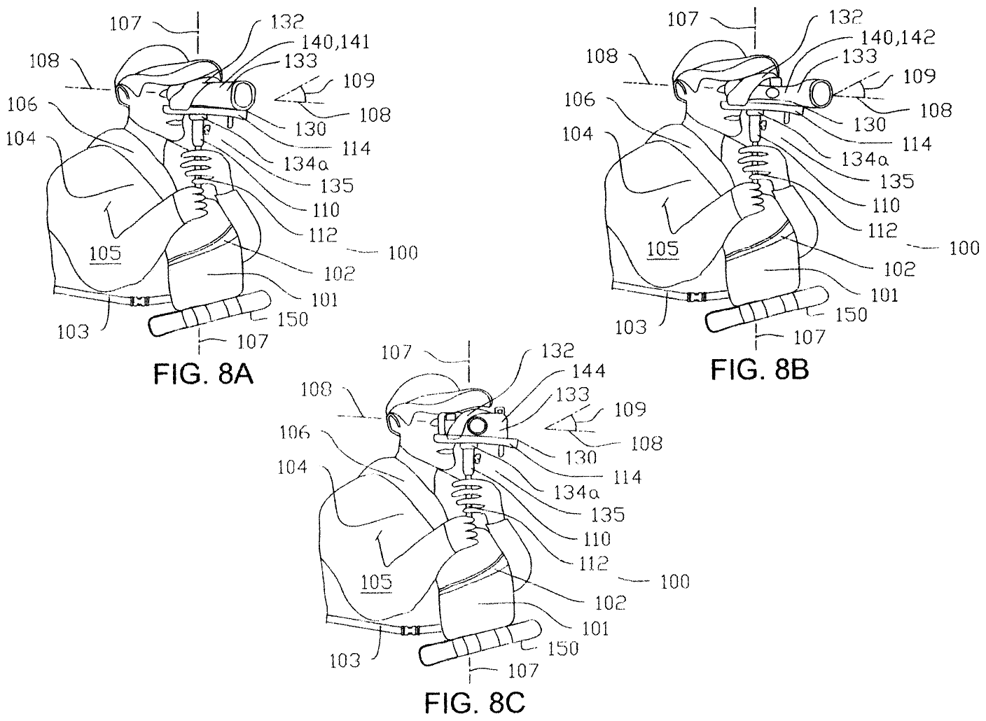

The viewing instrument 133, depicted in FIG. 2, to the body mounted viewing instrument support apparatus 100 of the present invention comprises at least one of a camera 144, for viewing and recording the scene, or any type of ocular instrument 140 used in the field for telescopic viewing and/or visual recording of wildlife, other natural phenomenon and other views. The ocular instrument 140 may be at least one of monocular 141, a hunting scope 142 or a pair of binoculars 143, or other ocular instrument 140 employed in this activity, as shown in FIGS. 2 and 8A-C.

The adjustable and lockable hinge 135, shown in FIGS. 2, 3 and 6B, allows the user 105 to adjust a viewing angle 109 for the generally rectangular platform 114 cooperatively and supportingly, or latitudinally/horizontally level or parallel, with the user's eyesight level 108 and relative to and along the longitudinal axis 107 of the telescoping monopod 110. The user 105 may thereby adjust the generally rectangular platform 114, in turn adjusting the viewing angle 109 through the viewing instrument 133. The adjustable and lockable hinge 135 further allows for the viewing angle 109 of the generally rectangular platform 114, to be adjusted up or down, at most to 45 degrees relative to the user's eyesight level 108, as shown in FIG. 2 and generally depicted in FIGS. 8A-C.

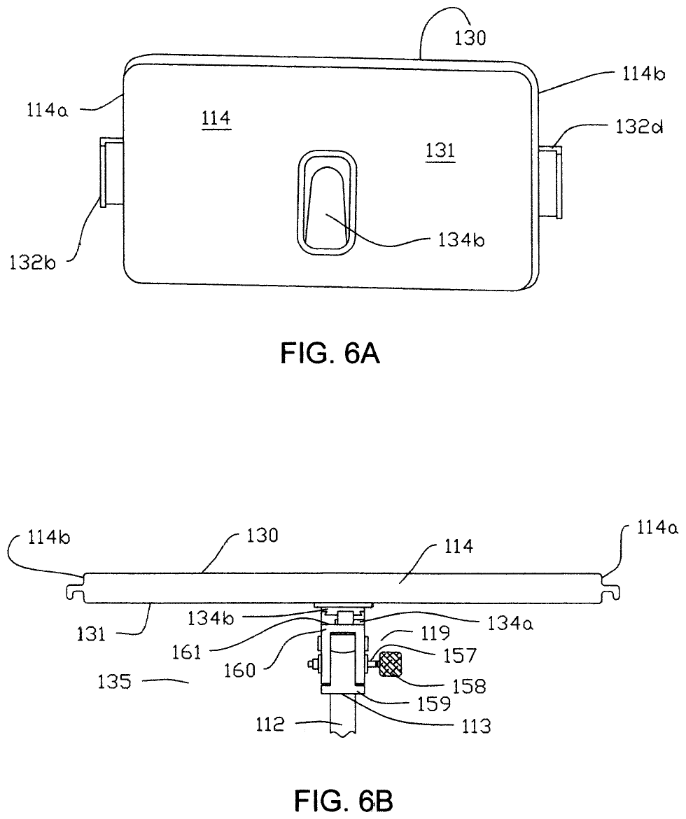

Another embodiment of the viewing instrument support apparatus of the present invention provides, as shown in FIGS. 1, 3 and 6B; the adjustable and lockable hinge 135 with a hinge housing 159 securely wrapped around the monopod shaft 112 at the platform end 113, a pivoting block 160 cooperatively and attachedly pivoting over the hinge housing 159 and an angle adjusting gear mechanism 119. The quick releasing means 134a is attached to a pivoting block top surface 161 of the pivoting block 160, shown in FIG. 6B. The angle adjusting gear mechanism 119 includes an adjustable tension screw 158 tightenly operating against a plurality of compressible washers and spacers 157 located between the adjustable tension screw 158 and the pivoting block 160.

As depicted in FIGS. 1-4B, and 6A and 6B, the generally rectangular platform 114 further has a first platform side 114a and an opposing second platform side 114b. As particularly depicted in FIGS. 4A and 4B, the first platform side 114a has a strap connecting and pivoting means 132b and the opposing second platform side 114b has a latching means 132d. The removable platform strap 132 pivotally and securely engages the viewing instrument 133 against the upper platform surface 130, also shown in FIGS. 8A-C. The removable platform strap 132 comprises a pivoting end 132a and an opposing latching end 132c. The opposing latching end 132c securely and freely attaches to the latching means 132d, which is any means functioning to secure the opposing latching end 132c, such as a grommet or latch or other securing and holding means commonly used to connect the end of the removable platform strap 132. The removable platform strap 132 is made of soft rubber or other flexible, durable material.

The strap connecting and pivoting means 132b enables the removable platform strap 132 to pivot away from the latching means 132d, functioning in a manner as a flexible, durable material would operate to repeatedly pivot the removable platform strap 132. The removable platform strap 132 being connected to the upper platform surface 130 of the generally rectangular platform 114. The latching means 132d enables the removable platform strap 132 to pivotally and securely latch to the viewing instrument 133. When the opposing latching end 132c is unconnected from the latching means 132d, thereby releasing the viewing instrument 133, which may then be quickly replaced with another viewing instrument 133 or separately stored or transported.

Another embodiment of the present invention embodies a viewing instrument support method, depicted in FIGS. 1 and 2, providing a pack 101, having at least one pack compartment 102, a pack front side 170, an opposing pack back side 180, and securing the pack 101 to an upper front torso 104 of a user 105 by a pack strap 103, and installing the pack 101 to the upper front torso 104 of the user 105 by at least one shoulder strap 106. A port member socket 111 is anchored within the pack 101, at the opposing pack back side 180, and centrally and firmly disposed within the pack strap 103 adjacent to the upper front torso 104, as depicted in FIG. 7. This method upwardly orients the port member socket 111 for receiving a telescoping monopod 110.

The method of the present invention provides the telescoping monopod 110, shown in FIG. 1 comprising a monopod shaft 112, a platform end 113, a generally rectangular platform 114, and an opposing port end 115. The platform end 113 supporting and cooperatively connects to the generally rectangular platform 114. The monopod shaft 112 is provided with at least two pod sections 116, each of the at least two pod sections 116 having the at least one detachable vertically adjusting means 117 allowing vertical adjustment of the telescoping monopod 110, and a shaft socket fitting 118 at the opposing port end 115. The method provides removably and securely fitting or anchoring the shaft socket fitting 118 within the port member socket 111 at the opposing port end 115.

This method of the present invention has the generally rectangular platform 114, shown in FIGS. 1, 2 and 3, comprising an upper platform surface 130 and an opposing lower platform surface 131, and a removable platform strap 132 freely securing a viewing instrument 133 onto the upper platform surface 130. The method laterally disposes and cooperatively and centrally connects the generally rectangular platform 114 at the opposing lower platform surface 131 to the monopod shaft 112 at the platform end 113, and longitudinally disposes and orients the telescoping monopod 110 along a longitudinal axis 107 at the upper front torso 104 of the user 105, thereby allowing the telescoping monopod 110 to be vertically adjustable to a user's eyesight level 108, by the at least one detachable vertically adjusting means 117. At the same time, the method is securely supporting and stabilizing the telescoping monopod 110 by the pack 101, with the port member socket 111, as discussed above. Thus, the viewing instrument support method of this embodiment of the present invention, allows for convenient and efficient use of any viewing instrument 133 by the user 105.

In one embodiment of the present invention, the method further comprises locating a quick releasing means 134a, shown in FIGS. 1, 2 and 6B, on the monopod shaft 112 of the telescoping monopod 110 adjacent to the platform end 113; centrally locating a releasing catch means 134b on the opposing lower platform surface 131 and locating an adjustable and lockable hinge 135 along the monopod shaft 112 between the quick releasing means 134a and the opposing port end 115, proximal to the quick releasing means 134a. This method allows the user 105 to adjust a viewing angle 109 for the generally rectangular platform 114, cooperatively and supportingly, by using the adjustable and lockable hinge 135, adjusting the viewing angle 109 to commensurate with the user's eyesight level 108 and relative to and along the longitudinal axis 107 of the telescoping monopod 110. By this method, the releasing catch means is cooperatively and securely engaging the releasing catch means 134b, thereby securing the monopod shaft 112 to the generally rectangular platform 114. The monopod shaft 112 is conveniently and quickly released from the generally rectangular platform 114. The quick releasing means 134a securely and cooperatively engage with the releasing catch means 134b to secure the monopod shaft 112 to the generally rectangular platform 114. As well, this embodiment allows the quick releasing means 134a to conveniently release the monopod shaft 112 from the generally rectangular platform 114.

In another embodiment of the present invention, the telescoping monopod 110, shown in FIGS. 1, 3, 6A and 6B; provides the quick releasing means 134a further comprising a cotter pin, a spring loaded snap lever, or a pressure engaging mechanism.

Another embodiment of the viewing instrument support method of the present invention provides the viewing instrument 133 further comprising at least one of a camera 144 or an ocular instrument 140, as depicted in FIG. 2. The ocular instrument shown in FIG. 2 is a pair of binoculars 143. The ocular instrument 140 may further comprise at least one of a monocular 141, a hunting scope 142 or a pair of binoculars 143, as depicted in FIGS. 8A-C.

Another embodiment of the viewing instrument support method of the present invention provides, as shown in FIGS. 1, 3 and 6B; the adjustable and lockable hinge 135 with a hinge housing 159 securely wrapped around the monopod shaft 112 at the platform end 113, a pivoting block 160 cooperatively and attachedly pivoting over the hinge housing 159 and an angle adjusting gear mechanism 119. The quick releasing means 134a is attached to a pivoting block top surface 161 of the pivoting block 160, shown in FIG. 6B. The angle adjusting gear mechanism 119 includes an adjustable tension screw 158 tightenly operating against a plurality of compressible washers and spacers 157 located between the adjustable tension screw 158 and the pivoting block 160. This method of the present invention thereby allows adjustment of the adjustable tension screw 158 against the plurality of compressible washers and spacers 157, creating sufficient tension within the adjustable and lockable hinge 135 between the hinge housing 159 and the pivoting block 160, in order to stabilize the generally rectangular platform 114, and allow the generally rectangular platform 114 to maintain its desired position, when being moved under tension.

Another embodiment of the viewing instrument support method of the present invention provides, as shown in FIGS. 1, 2, 5 and 7; accommodating, storing and transporting, the at least two pod sections 116 in an at least one sturdy monopod compartment 150 in the pack 101 and securing the at least two pod sections 116 with a compartment cap 151 as part of and closing the at least one sturdy monopod compartment 150 to the pack 101. The at least one sturdy monopod compartment 150 is constructed or made with a plurality of fabric material pieces sown together 152 with padded fabric material 153. This method thereby allows for effective transport of the viewing instrument 133 in the pack 101.

In another embodiment of the present method invention, the at least one detachable vertically adjusting means 117, depicted in FIG. 1, comprises, or is made of, cooperative threaded connections 156.

In another embodiment of the present method invention, the plurality of fabric material sown pieces together 152, shown in FIG. 5, are made of cordera nylon.

In another embodiment of the present method invention, the adjustable and lockable hinge 135 to the telescoping monopod 110, shown in FIGS. 1, 2 and 6B; further comprises, and allows, the viewing angle 109 to adjust 45 degrees, up or down from the generally rectangular platform 114 relative to the user's eyesight level 108, as shown in FIG. 2, and generally depicted in FIG. 8A-C. With this method, having the quick releasing means 134a mounted to the adjustable and lockable hinge 135, the user 105 is allowed to have the viewing angle 109 above and below the user's eyesight level 108.

In another embodiment of the present method invention, the viewing instrument support method, the generally rectangular platform 114, as shown in FIGS. 1, 2, and 6 A-B, provides a first platform side 114a and an opposing second platform side 114b, the first platform side 114a having a strap connecting and pivoting means 132b and the opposing second platform side 114b having a latching means 132d. This method connects the removable platform strap 132 to the upper platform surface 130 of the generally rectangular platform 114. The removable platform strap 132 comprises a pivoting end 132a and an opposing latching end 132c. The method securely and freely attaches the opposing latching end 132c to the latching means 132d, enabling the removable platform strap 132 to pivot away from the latching means 132d when the opposing latching end 132c is unconnected from the latching means 132d. The method pivotally and securely engages the particular viewing instrument 133, in this manner, against the upper platform surface 130 with the removable platform strap 132 on the generally rectangular platform 114.

In an alternative embodiment of the present method invention, the adjustable and lockable hinge 135 and the quick releasing means 134a are aluminum.

In an alternative embodiment of the present method invention, the at least two pod sections, shown in FIG. 1, are carbon fiber.

In another alternative embodiment of the present invention, the method provides for pivotally engaging the removable platform strap 132 against the upper platform surface 130 and thereby securing the viewing instrument 133. FIGS. 1 and 7 show that the present invention utilizes the pack 101 to hold the pair of binoculars 143, or other viewing instrument 133, as well as to stabilize such viewing instrument 133 with the telescoping monopod 110. Thus, the invention will provide a better apparatus and method for pursuing birding and wildlife watching.

All of the elements of the present invention of a body mounted viewing instrument support apparatus and method are designed to work together, as demonstrated by the FIGS. 1-8C. The pack 101 is, therefore, just as critical as any of the other elements, in this integrated apparatus and method. A telescoping monopod 110 would not be nearly as effective if not stabilized by the pack 101, as in this invention. The invention provides for a dedicated “mounting pocket” in the pack 101, the port member socket 11 shown in FIG. 7, in which to place the shaft socket fitting 118 of the monopod shaft 112 for stability. The pack 101, when worn by the user 105, as shown in FIG. 2, provides stability that cannot achieved by the user 105 merely holding onto a pair of binoculars 143, or other viewing instrument 133, or even simply the telescoping monopod 110 itself, with the pack 101. When the bottom of the monopod shaft 112, the opposing port end 115 having the shaft socket fitting 118 is placed in the pack 101, at the port member socket 111, at the opposing pack back side 180, as shown in FIG. 7, the viewing of the user 105 is stabilized by support of the viewing instrument 133 on a much more stable platform, the generally rectangular platform 114, shown in FIG. 2, than by the user 105 simply holding the viewing instrument 133 with his or her hands.

The pack 101 is also critical to ease shoulder strain for the user 105 and for allowing for the user's 105 extended time viewing through the pair of binoculars 143 or other viewing instrument 133, as depicted in FIGS. 2, 5 and 8A-C. In addition, the present invention also relieves the tension on the shoulders of the user 105, shown in FIG. 2, by allowing the user 105 to hold the telescoping monopod 110 and generally rectangular platform 114 at chest, or upper front torso 104 level in the pack 101 which is not only more comfortable but also adds to the stability.

The body mounted viewing instrument support apparatus 100, shown in FIG. 2, makes using any pair of binoculars 143 or other viewing instrument 133 into a stabilized and pain free activity for viewing birds and other wildlife. By attaching the viewing instrument 133 to the generally rectangular platform 114 and stabilizing the telescoping monopod 110 in the pack 101, the user 105 is able to support the viewing instrument 133 for angled viewing without having to hold it to the user's eyesight level 108 with his or her hands above the shoulders.

The present invention also provides for an easy way for the user 105 to carry all the components or elements of the invention and still be highly mobile while hiking and have them readily available for use, as shown in FIGS. 2 and 7. In one embodiment, depicted in FIGS. 2 and 5, the pack 101 has at least one sturdy monopod compartment 150 to carry the at least two pod sections 116 of the telescoping monopod 110. As well, as shown in FIG. 2, there is at least one pack compartment 102, which may be located in the pack front side 170 of the pack 101, available to transport other elements of the body mounted viewing support apparatus 100, such as the generally rectangular platform 114. The pack 101 provides for an efficient, safe, secure and comfortable way to carry the entire system with dedicated pockets and sleeves for each of the components. This allows for comfortable hiking and transport to any viewing destination.

Having thus described in detail a preferred selection of embodiments of the present invention, it is to be appreciated, and will be apparent to those skilled in the art, that many physical changes could be made in the device without altering the invention, or the concepts and principles embodied therein. Unless otherwise specifically stated, the terms and expressions have been used herein as terms of description and not terms of limitation, and are not intended to exclude any equivalents of features shown and described or portions thereof. Various changes can, of course, be made to the preferred embodiment without departing from the spirit and scope of the present invention. The present invention apparatus, therefore, should not be restricted, except in the following claims and their equivalents.

Although specific advantages have been enumerated above, various embodiments may include some, none, or all of the enumerated advantages.

Other technical advantages may become readily apparent to one of ordinary skill in the art after review of the following figures and description.

It should be understood at the outset that, although exemplary embodiments are illustrated in the figures and described herein, the principles of the present disclosure may be implemented using any number of techniques, whether currently known or not. The present disclosure should in no way be limited to the exemplary implementations and techniques illustrated in the drawings and described herein.

Unless otherwise specifically noted, articles depicted in the drawings are not necessarily drawn to scale.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

I claim:

1. A body mounted viewing instrument support apparatus, comprising:
(a) a pack, comprising: at least one pack compartment, a pack front side, an opposing pack back side, a pack strap securing the pack to an upper front torso of a user, at least one shoulder strap to install the pack to the upper front torso of the user and a port member socket fitted within the pack at the opposing pack back side and centrally and firmly disposed proximal to the pack strap adjacent to the upper front torso;
(b) the port member socket upwardly oriented for freely receiving a telescoping monopod;
(c) the telescoping monopod comprising: a monopod shaft, a platform end, a generally rectangular platform, and an opposing port end; and
(d) the platform end supporting and cooperatively connecting to the generally rectangular platform;
(e) the monopod shaft having at least two pod sections, each of the at least two pod sections having at least one detachable vertically adjusting means allowing vertical adjustment of the telescoping monopod and detachment of the at least two pod sections;
(f) the opposing port end having a shaft socket fitting;
(g) the shaft socket fitting removably and securely anchoring within the port member socket at the opposing port end;
(h) the generally rectangular platform comprising: an upper platform surface and an opposing lower platform surface, and a removable platform strap freely securing a viewing instrument onto the upper platform surface;
(i) the generally rectangular platform being laterally disposed and cooperatively and centrally received at the opposing lower platform surface by the monopod shaft at the platform end;
(j) the telescoping monopod being longitudinally disposed and oriented along a longitudinal axis at the upper front torso of the user;
(k) the at least one detachable vertically adjusting means allowing adjustment of the telescoping monopod to a user's eyesight level; and
(l) the pack securely supporting and stabilizing the telescoping monopod allowing use of the body mounted viewing instrument support apparatus by the user.

2. The body mounted viewing instrument support apparatus of claim 1, further comprising:
(a) a quick releasing means located on the monopod shaft adjacent to the platform end and a releasing catch means centrally located on the opposing lower platform surface;
(b) an adjustable and lockable hinge located along the monopod shaft between the quick releasing means and the opposing port end, immediately proximal to and attaching to the quick releasing means;
(c) the adjustable and lockable hinge allowing the user to adjust a viewing angle for the generally rectangular platform cooperatively and supportingly with the user's eyesight level and relative to and along the longitudinal axis of the telescoping monopod;
(d) the quick releasing means cooperatively and securely engaging the releasing catch means, securing the monopod shaft to the generally rectangular platform;
(e) the quick releasing means conveniently and quickly releasing the monopod shaft from the generally rectangular platform; and
(f) the viewing angle adjusting up or down to 45 degrees from the generally rectangular platform relative to the user's eyesight level.

3. The body mounted viewing instrument support apparatus of claim 1, wherein the viewing instrument further comprising: at least one of a camera or an ocular instrument.

4. The viewing instrument of claim 3, wherein the ocular instrument further comprising: at least one of a monocular, a hunting scope or a pair of binoculars.

5. The body mounted viewing instrument support apparatus of claim 1, wherein the adjustable and lockable hinge comprising:
(a) a hinge housing securely wrapped around the monopod shaft at the platform end, a pivoting block cooperatively and attachedly pivoting over the hinge housing, and an angle adjusting gear mechanism, including an adjustable tension screw tightenly operating against a plurality of compressible washers and spacers located between the tension screw and the pivoting block; and
(b) the quick releasing means attaching to a pivoting block top surface of the pivoting block.

6. The body mounted viewing instrument support apparatus of claim 1, the pack further comprising:
(a) at least one sturdy monopod compartment accommodating the at least two pod sections;
(b) a compartment cap securing the at least two pod sections within the at least one sturdy monopod compartment; and
(c) the at least one sturdy compartment constructed of a plurality of fabric material pieces sown together and constructed of padded fabric material.

7. The detachable vertically adjusting means of claim 1 further comprising cooperative threaded connections.

8. The pack of claim 6 wherein the plurality of fabric material pieces sown together are made of cordera nylon.

9. The telescoping monopod of claim 2, wherein the adjustable and lockable hinge and the quick releasing means are aluminum.

10. The body mounted viewing instrument support apparatus of claim 1, wherein at least two pod sections are carbon fiber.

11. The body mounted viewing instrument support apparatus of claim 1, the generally rectangular platform further comprising:
(a) a first platform side and an opposing second platform side;
(b) the first platform side having a strap connecting and pivoting means and the opposing second platform side having a latching means;
(c) the removable platform strap being connected to the upper platform surface of the generally rectangular platform;
(d) the removable platform strap comprising: a pivoting end and an opposing latching end;
(e) the opposing latching end securely and freely attaching to the latching means;
(f) the strap connecting and pivoting means enabling the removable platform strap to pivot away from the latching means when the opposing latching end is unconnected from the latching means; and
(g) the removable platform strap pivotally and securely engaging the viewing instrument against the upper platform surface.

12. A viewing instrument support method, comprising:
(a) providing a pack, comprising: at least one pack compartment, a pack front side, an opposing pack back side, and securing the pack to an upper front torso of a user by a pack strap,
(b) installing the pack to the upper front torso of the user by at least one shoulder strap and fitting a port member socket within the opposing pack back side and centrally and firmly disposed proximal to the pack strap adjacent to the upper front torso;
(c) upwardly orienting the port member socket for receiving a telescoping monopod;
(d) providing the telescoping monopod comprising: a monopod shaft, a platform end, a generally rectangular platform, and an opposing port end;
(e) cooperatively connecting and supporting the generally rectangular platform by and with the platform end;
(f) providing the monopod shaft with at least two pod sections, and allowing vertical adjustment of the telescoping monopod by having a detachable vertically adjusting means to each of the at least two pod sections;
(g) having a shaft socket fitting to the opposing port end;
(h) removably and securely anchoring the shaft socket fitting within the port member socket at the opposing port end;
(I) having the generally rectangular platform comprising: an upper platform surface and an opposing lower platform surface, and a removable platform strap freely securing a viewing instrument onto the upper platform surface;
(j) laterally disposing and cooperatively and centrally receiving the generally rectangular platform at the opposing lower platform surface by the monopod shaft at the platform end;
(k) longitudinally disposing and orienting the telescoping monopod along a longitudinal axis at the upper front torso of the user,
(l) adjusting the telescoping monopod to a user's eyesight level with the at least one detachable vertically adjusting means; and
(m) securely supporting and stabilizing the telescoping monopod with the pack, allowing for convenient and efficient use of a viewing instrument by the user.

13. The viewing instrument method of claim 12, further comprising:
(a) locating a quick releasing means on the monopod shaft adjacent to the platform end and centrally locating a releasing catch means on the opposing lower platform surface;
(b) locating an adjustable and lockable hinge along the monopod shaft between the quick releasing means and the opposing port end, immediately proximal to and attaching to the quick releasing means;
(c) allowing the user to adjust a viewing angle for the generally rectangular platform by the adjustable and lockable hinge, cooperatively and supportingly with the user's eyesight level and relative to and along the longitudinal axis of the telescoping monopod;
(d) cooperatively and securely engaging the releasing catch means to the quick releasing means thereby securing the monopod shaft to the generally rectangular platform;
(e) allowing the quick releasing means to securely and cooperatively engage with the releasing catch means, and securing the monopod shaft to the generally rectangular platform;
(f) conveniently and quickly releasing the monopod shaft from the generally rectangular platform by the quick releasing means;
(g) adjusting the viewing angle 45 degrees up or down from the generally rectangular platform relative to the user's eyesight level; and
(h) allowing the user to have the viewing angle above and below the user's eyesight level.

14. The viewing instrument support method of claim 12, wherein the viewing instrument further comprising: at least one of a camera or an ocular instrument.

15. The viewing instrument of claim 14, wherein the ocular instrument further comprising: at least one of a monocular, a hunting scope or a pair of binoculars.

16. The viewing instrument support method of claim 13, further comprising:
(a) providing the adjustable and lockable hinge comprising: a hinge housing securely wrapped around the monopod shaft at the platform end, a pivoting block cooperatively and attachedly pivoting over the hinge housing and an angle adjusting gear mechanism;
(b) providing the angle adjusting gear mechanism including an adjustable tension screw tightenly operating against a plurality of compressible washers and spacers located between the adjustable tension screw and the pivoting block;
(c) attaching the quick releasing means to a pivoting block top surface of the pivoting block; and
(d) thereby allowing adjustment of the tension screw against the plurality of compressible washers and spacers creating sufficient tension within the adjustable and lockable hinge between the hinge housing and the pivoting block to stabilize the generally rectangular platform.

17. The viewing instrument support method of claim 12, further comprising:
(a) accommodating the at least two pod sections in an at least one sturdy monopod compartment in the pack;
(b) securing the at least two pod sections with a compartment cap to the at least one sturdy monopod compartment of the pack;
(c) constructing the at least one sturdy monopod compartment with a plurality of fabric material pieces sown together with padded fabric material; and
(d) thereby allowing for effective transport of the viewing instrument in the pack.

18. The detachable vertically adjusting means of claim 12 further comprising: cooperative threaded connections.

19. The viewing instrument support method of claim 17, further comprising: the plurality of fabric material sown pieces together are cordera nylon.

20. The telescoping monopod of claim 13, wherein the adjustable and lockable hinge and the quick releasing means are aluminum.

21. The viewing instrument support method of claim 12, wherein the at least two pod sections are carbon fiber.

22. The viewing instrument support method of claim 12, wherein the generally rectangular platform further comprising:
(a) having a first platform side and an opposing second platform side, the first platform side having a strap connecting and pivoting means and the opposing second platform side having a latching means;
(b) connecting the removable platform strap to the upper platform surface of the generally rectangular platform, the removable platform strap comprising: a pivoting end and an opposing latching end;
(c) securely and freely attaching the opposing latching end to the latching means;
(d) enabling the removable platform strap to pivot away from the latching means when the opposing latching end is unconnected from the latching means; and
(e) pivotally and securely engaging the viewing instrument against the upper platform surface with the removable platform strap.
